(19) United States
(12) Patent Application Publication
(10) Pub. No.: US 2025/0299091 A1
(43) Pub. Date: Sep. 25, 2025

(54) SYSTEMS AND METHODS TO EVALUATE MACHINE LEARNING MODELS FOR DETERMINISTIC RELATIONS

(71) Applicant: SAP SE, Walldorf (DE)

(72) Inventors: Tim BREITENBACH, Oberleichtersbach (DE); Saleh GHOLAM ZADEH, Heidelberg/baden-württemberg (DE); Patrick Jahnke, Leimen (DE)

(21) Appl. No.: 18/611,538

(22) Filed: Mar. 20, 2024

(51) Int. Cl. G06N 20/00

(52) U.S. Cl. CPC G06N 20/00

(57) ABSTRACT

Described herein are techniques for determining whether a trained machine learning model has captured all of the deterministic relations in a dataset. In some examples, the techniques may be applied to the training dataset along with the validation or test dataset. First, the input variables from the dataset are fed into the trained machine learning model to generate predicted outputs. Second, the correctness of the predicted outputs is compared against the output variables from the dataset, also known as the ground truth. The correctness is represented by residuals. Third, the residuals and the input variables are correlated. If correlation exists, then the trained machine learning model has not captured all of the deterministic relations in the dataset.

### BACKGROUND

Unless otherwise indicated herein, the approaches described in this section are not prior art to the claims in this application and are not admitted to be prior art by inclusion in this section.

Machine learning (ML) models are programs that can analyze unseen data to find patterns or make decisions. In order to do so, the ML model is first trained with a training dataset. A common procedure used for training and evaluating ML models is to define a loss function that defines how close the ML model output variables are to the training data. The training data is also known as ground truth. In real world scenarios, it may be difficult for the ML model to achieve the best possible loss function value due to the presence of noise. Since training a ML model is both time and resource intensive, there is a need to automatically determine whether the presence of errors in the ML model according to the loss function value is due to noise or because the trained ML model has additional information it can learn from the training data.

### BRIEF DESCRIPTION OF THE DRAWINGS

FIG. 1 illustrates a system for training a ML model according to some embodiments.

FIG. 2 illustrates the model training block according to some embodiments.

FIG. 3 illustrates an exemplary implementation of a trained ML model analyzer according to some embodiments.

FIG. 4 illustrates an exemplary workflow for training a ML model according to some embodiments.

FIG. 5 depicts a simplified block diagram of an example computer system, which can be used to implement some of the techniques described in the foregoing disclosure.

### DETAILED DESCRIPTION

Described herein are methods and apparatuses to train a ML model. The performance of a ML model depends on the training and the training may be evaluated by defining a loss function or accuracy score. The loss function defines how close the ML model's output variables are to the ground truth. For example, training data may store a set of entries where each entry includes one or more input variables and one or more output variables. The output variables are the result that is expected when the input variables are fed into the ML model. In other words, the output variables in the training dataset are the ground truth. While training dataset is mentioned here, any dataset that is provided for purposes of training or testing the model (such as testing dataset, validation dataset, etc.) can be considered the ground truth.

During training and testing of the ML model, there may be some inherent noise due in the system which may affect the output generated by the ML model. For example in a cloud environment where the ML model is to allocate compute resources, the compute resources may have random utilization which is not predictable and learnable by the ML model. The accuracy scores of the ML model may be dependent on this noise so therefore it's important to differentiate low accuracy scores due to a high amplitude of noise and low accuracy scores due to the ML model performance. In some embodiments, ML model training includes a model performance evaluator configured to analyze a trained ML model along with the training dataset to determine whether the trained ML model has captured all of the deterministic relations within the training dataset. By evaluating performance of the ML model based on deterministic relationships rather than loss function or accuracy score, the ML model training can accurately determine when the trained ML model has learned all there is to learn from the training dataset, thereby making the ML training more efficient. Advantages to this solution include the avoidance of overfitting which may occur when the model is further trained to account for the noise.

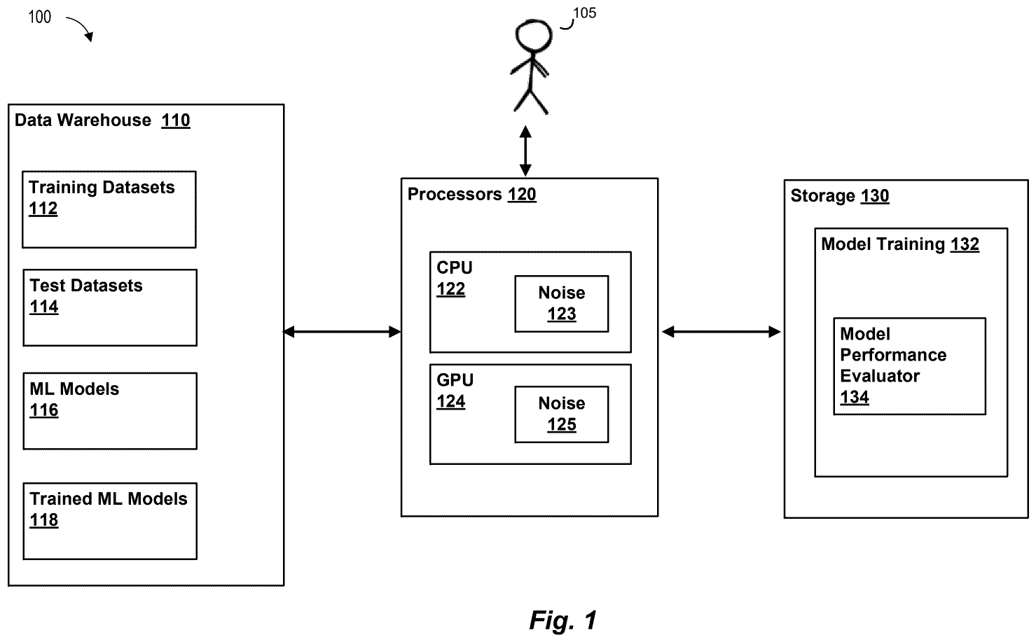

FIG. 1 illustrates a system for training a ML model according to some embodiments. System 100 includes user 105, data warehouse 110, processors 120, and storage 130. Processors 120, which include CPU 122 and GPU 124 are configured to process computer readable instructions from storage 130 to process data and ML models from data warehouse 110. As shown here, CPU 122 may experience noise 123 that is random and non-deterministic. Similarly, GPU 124 may experience noise 125 that is also random and non-deterministic. Noise 123 and 125 may have a negative effect to the training of ML models since the noise affects the output of the ML models so therefore, solutions for training ML models that can negate the noise are advantageous.

Data warehouse 110 includes training datasets 112, test datasets 114, ML models 116, and trained ML models 118. Training datasets 112 include datasets which are utilized during training of ML models. Similarly, test datasets 114 include datasets which are utilized during testing of ML models. Each dataset may contain a plurality of entries used for training (or testing) the ML models. Each entry within a dataset includes input variables and output variables. The input variables are input into a ML model and the output variables are the desired output from the ML model. The output variables are known as ground truth. In some embodiments, a training dataset may be used in training the ML model and the testing dataset is used to test the trained ML model to determine whether the trained ML model is able to accurately predict the ground truth. If the ML model performs poorly on the test dataset, then the ML model may be retrained. Retraining can include selecting another ML model architecture, changing the hyperparameters of the ML model, and changing the loss function, to name a few. ML models 116 may store ML models that can be selected as a ML architecture to use when training a ML model with a training dataset. Trained ML models can be stored in trained ML models 118.

Storage 130 stores computer readable instructions which, when executed by one or more processors in processors 120, can train a ML model. The computer readable instructions can include model training block 132 which trains a ML model and model training block 132 can include model performance evaluator block 134. Each block can be a block of software code which can be executed by CPU 122 or GPU 124. In one embodiment, model performance evaluator can contain computer code to determine whether the training dataset includes input/output variables that have deterministic relations. In another embodiment, model performance evaluator can determine whether a trained ML model has captured all of the deterministic relations in the input/output variables of the training dataset. If the trained ML model has captured all the deterministic relations in the training dataset, then training can conclude. In contrast if the trained ML model has not captured all of the deterministic relations, then the trained ML model can be further modified to learn the deterministic relations not yet captured.

Here, user 105 may provide instructions to processor 120 train a ML model. In one example, user 105 may define the ML model to use, the training dataset to use, and a starting configuration for the ML model. Processor 120 may retrieve computer readable instructions from storage 130 to train the ML model, which can include model training 132. Processor 120 may also retrieve the desired training dataset and ML model from data warehouse 110 and execute computer readable code from storage 130 to train the ML model.

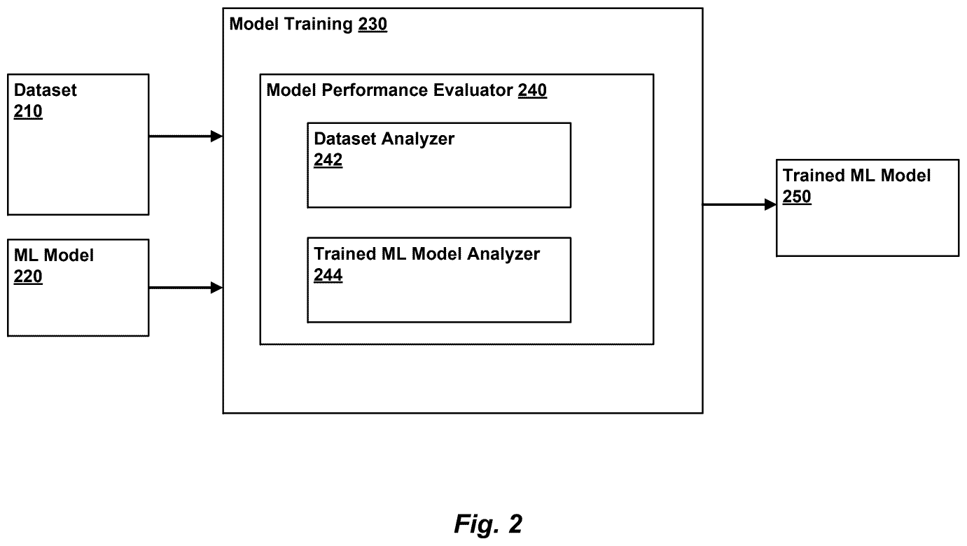

FIG. 2 illustrates the model training block according to some embodiments.

Model training block 230 represents a block of software code that is configured to train a ML model 220 with the use of dataset 210. Dataset 210 can be a training dataset, test dataset, validation dataset, or other dataset. The output of model training block 230 is trained ML model 250. Model training block 230 includes model performance evaluator block 240. Model performance evaluator block 240 is configured to evaluate the dataset for deterministic relations and to determine whether a trained ML model can further learn additional deterministic relations from the dataset. Model performance evaluator 240 includes dataset analyzer 242 and trained ML model analyzer 244. Dataset analyzer 242 is configured to analyze a dataset to determine whether there is correlation between the output variables and the input variables. Correlation may be defined as the opposite of independence, meaning that inputs and outputs take their values independent of each other. If there is correlation, then there are deterministic patterns that relate the input variables and the output variables of the dataset. These are also known as deterministic relations. With these deterministic relations, it is possible to predict the output from a given input and therefore, the dataset can be used to train a ML model. In contrast if there are no deterministic relations, then the input variables cannot be used to predict the output variables and therefore, a ML model would not be suitable. In one embodiment, dataset analyzer 242 performs a pairwise analysis in which it determines if there is correlation between an input variable and an output variable pair. This analysis can be performed for every combination of input and output variables to identify which pairs are correlated. In another embodiment, dataset analyzer analyzes each output variable to determine whether the output variable is correlated with one or more input variables. In this scenario, there can be a 1:many mapping between output variables and input variables. In general, dataset analyzer 242 is trying to determine if there is a relationship between the output the ML model is to predict and the input of the ML model. In some embodiments, dataset analyzer 242 determines simply whether there is a deterministic relationship between the input and output variables without specifying which output variables have a relationship with which input variables. This general conclusion may require less compute resources to determine and therefore is more efficient.

Determining whether the dataset has deterministic relations can be performed in numerous ways. In one embodiment, dataset analyzer 242 can determine whether the output and the input share mutual information. In one example, a mutual information value can be calculated that represents whether the output variables and the input variables of the dataset are correlated. In another embodiment, dataset analyzer 242 can determine whether the output and the input are stochastically independent. Stochastically independence means that the input variables do not affect output variables with respect to their taken values, and vice versa. In one embodiment, a stochastic independence value can be calculated that represents whether the output variables and input variables of the dataset are stochastically independent. In yet another embodiment, a Pearson correlation coefficient can be calculated between the input and output variables of the dataset that represents whether the input variables and output variables are correlated.

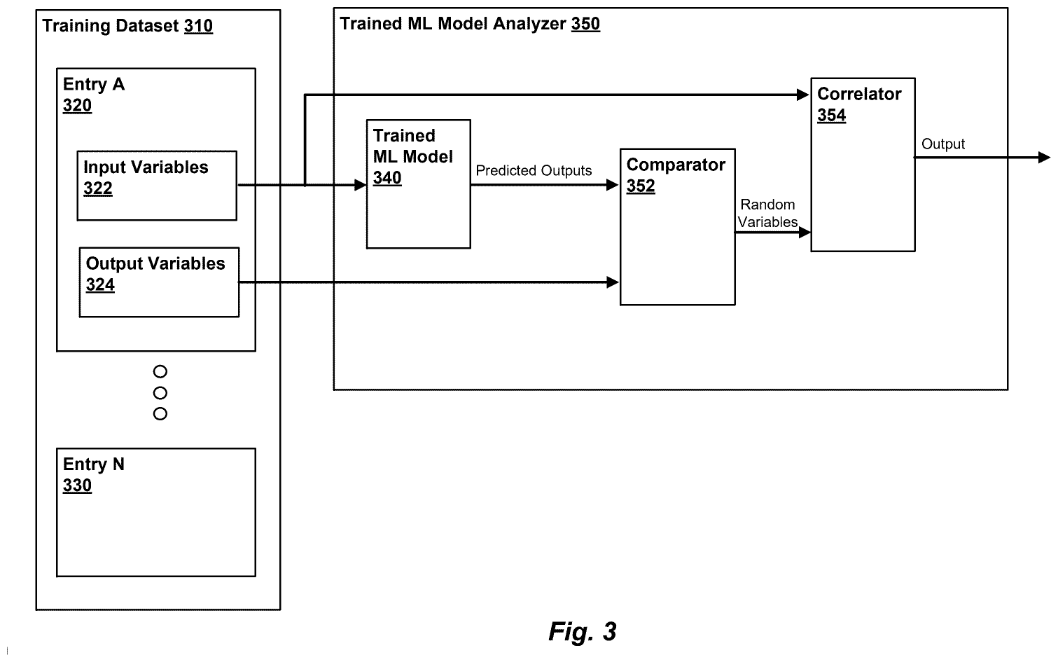

Trained ML model analyzer 244 is configured to analyze a trained ML model to determine whether the trained ML model has learned or captured all the deterministic relations in the dataset. If all the deterministic relations in the dataset have been captured in the trained ML model, then the trained ML model has been optimized and model training can conclude. On the other hand, if not all the deterministic relations in the dataset have been captured by the trained ML model, then the trained ML model can be further improved. In one embodiment, model training 230 may retrain the trained ML model when not all deterministic relations in the dataset have been captured by the trained ML model. Retraining can include selecting a different ML architecture for the ML model. Retraining can also include hyperparameter tuning to fine tune the ML model. Retraining can also include modification of the loss function. Details on how the trained ML model analyzer analyzes the trained ML model and the dataset to determine whether the trained ML model has captured all of the deterministic relations in the dataset are described below in FIG. 3.

FIG. 3 illustrates an exemplary implementation of a trained ML model analyzer according to some embodiments. As described above, the trained ML model analyzer is capable of analyzing the deterministic relations that the trained ML model has captured in the training dataset. The analysis can include determining whether there are deterministic relations in the training dataset that are not captured by the trained ML model. As shown in FIG. 3, trained ML model analyzer 350 receives training dataset 310 as an input. The input variables from training dataset 310 are provided as input into trained ML model 340 to generate predicted outputs. Each predicted output may correspond to an output variable of training dataset 310. In other words, there is a 1:1 mapping between the output variables and the predicted outputs. If the training dataset has two output variables (e.g., A, B), then the trained ML model also generates two predicted outputs (e.g., X, Y) and there would be a 1:1 mapping between them (X corresponds to A, Y corresponds to B). As shown here, entry A 320 is being analyzed by the trained ML model analyzer. Input variables 322 from entry A 320 are provided as input to trained ML model 340 to generate predicted outputs. The predicted outputs and the output variables 324 from entry A 320 are then provided as inputs to comparator 352. In some embodiments, the data type of a predicted output generated is the same as the data type as its corresponding output variable. For example, the data type of predicted output X is the same data type as output variable A.

Comparator 352 is configured to compare the predicted outputs with the output variables to determine the correctness of the prediction generated by the trained ML model. The comparator 352 may generate a random variable (also called a residual) for each comparison performed where the residual defines the correctness of the predicted output to the ground truth (i.e., output variable). If there are three predicted outputs and three output variables, then comparator 352 would perform three comparisons and generate three random variables.

In some embodiments, the way in which comparator 352 generates the residual may depend on the data type of the output variable. When the data type of the output variable is ordinal data, continuous data, or discretized data, comparator 352 may calculate the residual as the difference between the output variable and the predicted output. For example if the output variable is the number 5.8 and the predicted output is 7.2, then the comparator can generate a residual with a value that's the difference between 5.8 and 7.2, which is −1.4. In some embodiments, comparator 352 may generate the residual as an absolute value so in the example above, the residual would be simply 1.4. When the data type of the output variable is nominal data, comparator 352 may set the residual to a predetermined value when the predicted output is correct and to a different value when the predicted output is incorrect. For example, comparator 352 may set the residual to 1 when the predicted output is correct and set the residual to 0 when the predicted output is incorrect. In a different embodiment when the output variable is nominal data, comparator 352 may set the residual to the correct value when the predicted output is incorrect and set the residual to 0 when the predicted output is correct. For example, let's assume the output variable is nominal data type that is the days of the work week so the output variable could be set as Monday, Tuesday, Wednesday, Thursday, or Friday. Each of the possible outcomes can be assigned a number (Monday=1, Tuesday=2, Wednesday=3, Thursday=4, Friday=5). Let's assume the output variable is Wednesday however the predicted output is Monday. In this scenario, comparator 352 sets the residual to the value 3 since Wednesday is the ground truth. Similarly if the output variable is Tuesday and the predicted output is also Tuesday, then the comparator 352 sets the residual to the value 0 since the predicted output is correct.

After the comparator has processed all entries, each entry in training dataset is associated with a set of residuals that were generated by the comparator, where a residual was generated for each comparison performed (comparing a predicted output of the entry with the ground truth). Similarly, training dataset 310 also has input variables for each entry in the training dataset 310 so there is a 1:1 mapping between the input variables and the set of residuals for a given entry. And each residual is related to a corresponding output variable from the training dataset (i.e. ground truth) as described above.

As mentioned above, the generated residuals represent the correctness of the prediction of the ML model against the ground truth. If the prediction is correct, the residual value is zero. Correlator 354 receives the input variables along with the generated residuals and determines whether there is correlation between the input variables and the generated residuals. If there is no correlation, then trained ML model has captured all of the deterministic relations in the training dataset 310 and correlator 354 can output a result that there is no correlation. In contrast if there is correlation, then this means that the trained ML model has not captured all of the deterministic relations in the training dataset 310. Therefore, correlator 354 may identify in the output the residuals that are still correlated to the input variables. By identifying the residuals that are still correlated, the system is able to identify the output variables that correspond to the correlated residuals as output variables that can be further trained in the trained ML model. In some embodiments, the training dataset and the validation dataset can be utilized to determine whether all the deterministic relationships have been captured in the trained ML model. If they haven't all been captured, then the system can retrain the trained ML model. This retraining can include hyperparameter tuning, changing the loss function, or modifying the ML architecture, to name a few. Below is an example table illustrating three entries in the training dataset as rows, the ground truth for the output variables, the predicted output generated by the trained ML model, and also the generated residuals.

| Input | Ground | Ground | Prediction | Prediction | Residual | Residual |
|---|---|---|---|---|---|---|
| Variables | Truth A | Truth B | X | Y | X-A | Y-B |
| Input 1 | 5 | 3 | 5.5 | 1 | −0.5 | 2 |
| Input 2 | 2 | 4 | 1 | 4 | 1 | 0 |
| Input 3 | 7 | 8 | 5 | 9 | 2 | −1 |

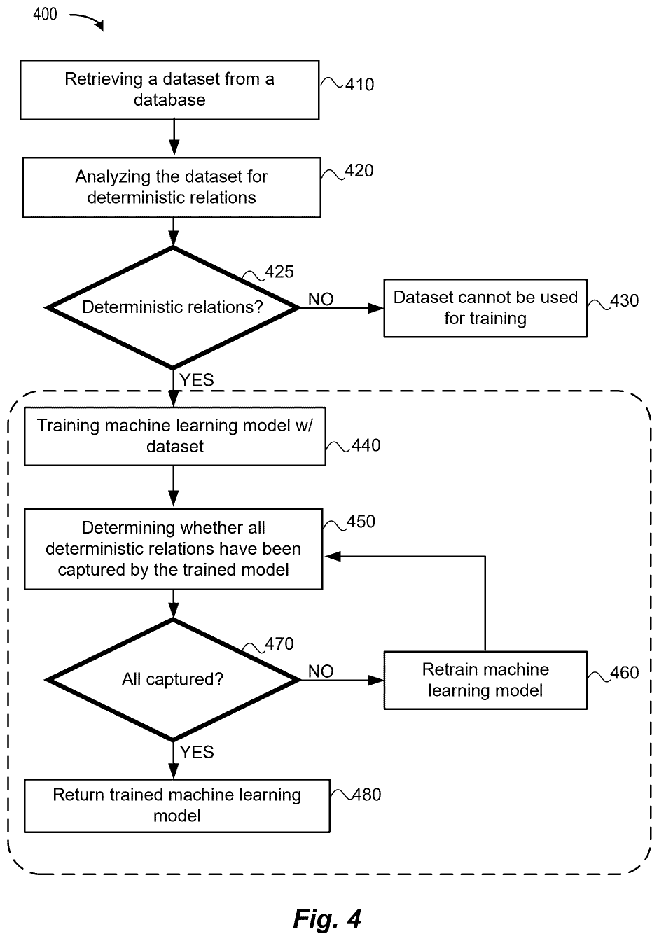

FIG. 4 illustrates an exemplary workflow for training a ML model according to some embodiments. Workflow 400 can be implemented as computer readable code that is stored in model training 230 of FIG. 2 and model performance evaluator 240 of FIG. 2, the code being executable by one or more processors from processors 120 of FIG. 1. Workflow 400 can begin by retrieving a dataset from a database at 410. In one example, the database is data warehouse 110 of FIG. 1. Depending on the implementation, the dataset can be any dataset that the user plans on using to train a ML model. Workflow 400 continues by analyzing the dataset for deterministic relations at step 420. In one embodiment, the analysis may include calculating the mutual information value that represents the correlation between the input and output variables of the dataset. In another embodiment, the analysis may include calculating a stochastic independence value that represents whether the input and output variables are stochastically independent. In yet another embodiment, the analysis may include calculating a Pearson correlation coefficient representing the correlation between the input and output variables.

Workflow 400 then determines whether there are deterministic relations in the dataset based on the analysis at 425. If there aren't deterministic relations, workflow 400 concludes that the dataset cannot be used for training a ML model at step 430. A different dataset may be retrieved and workflow 400 can restart. Alternatively, if there are deterministic relations in the dataset, workflow 400 continues by training the ML model with the dataset at step 440. In one embodiment, the ML model can be trained by modifying the ML model such that when the input variables from an entry of the dataset are input into the ML model, the output of the ML model is close to the output variables from the entry. In other embodiments, other common techniques to train a ML model with the use of a dataset can be applied.

Once the ML model has been trained with the use of the dataset, workflow 400 continues by determining whether all deterministic relations have been captured by the trained machine learning model at step 450. In one embodiment is performed by the trained ML model analyzer 244 of FIG. 2. An example implementation of the trained ML model analyzer is provided in FIG. 3. At step 470, workflow 400 checks whether all the deterministic relations have bene captured by the trained ML model. If all or some of the deterministic relations have not been captured, then workflow 400 continues with retraining the trained ML model at step 460. Retraining can include one or more of hyperparameter tuning, selecting a different loss function, or selecting a different ML architecture. After retraining, workflow 400 determines whether all the deterministic relations have been captured again at 450. This loop may repeat itself until all deterministic relations have been captured. Once all the deterministic relations have been captured, then workflow 400 continues by returning the trained ML model at 480. In some embodiments where it is known that the dataset (training, validation, test, etc.) includes deterministic relations, steps 410-430 can be skipped and workflow 400 can start at step 440 with the training of the ML model as shown in FIG. 4 with the dotted box.

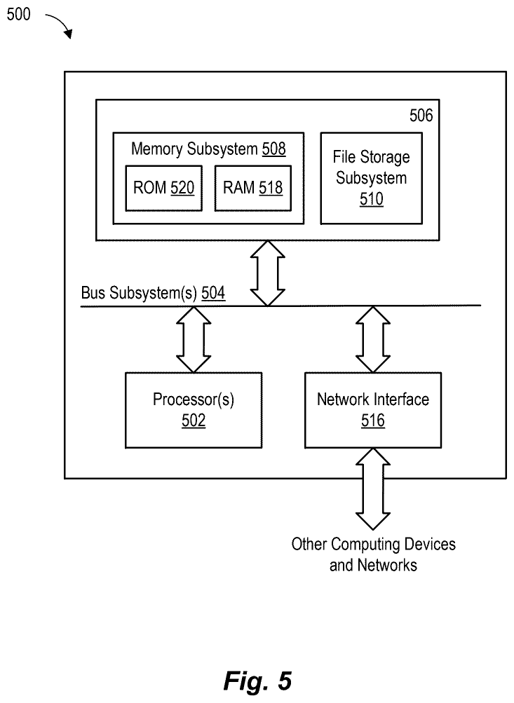

FIG. 5 depicts a simplified block diagram of an example computer system, which can be used to implement some of the techniques described in the foregoing disclosure. As shown in FIG. 5, system 500 includes one or more processors 502 that communicate with several devices via one or more bus subsystems 504. These devices may include a storage subsystem 506 (e.g., comprising a memory subsystem 508 and a file storage subsystem 510) and a network interface subsystem 516. Some systems may further include user interface input devices and/or user interface output devices (not shown).

Bus subsystem 504 can provide a mechanism for letting the various components and subsystems of system 500 communicate with each other as intended. Although bus subsystem 504 is shown schematically as a single bus, alternative embodiments of the bus subsystem can utilize multiple buses.

Network interface subsystem 516 can serve as an interface for communicating data between system 500 and other computer systems or networks. Embodiments of network interface subsystem 516 can include, e.g., Ethernet, a Wi-Fi and/or cellular adapter, a modem (telephone, satellite, cable, etc.), and/or the like.

Storage subsystem 506 includes a memory subsystem 508 and a file/disk storage subsystem 510. Subsystems 508 and 510 as well as other memories described herein are examples of non-transitory computer-readable storage media that can store executable program code and/or data that provide the functionality of embodiments of the present disclosure.

Memory subsystem 508 comprise one or more memories including a main random access memory (RAM) 518 for storage of instructions and data during program execution and a read-only memory (ROM) 520 in which fixed instructions are stored. File storage subsystem 510 can provide persistent (e.g., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that system 500 is illustrative and many other configurations having more or fewer components than system 500 are possible.

The above description illustrates various embodiments of the present invention along with examples of how aspects of the present invention may be implemented. The above examples and embodiments should not be deemed to be the only embodiments and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

### FURTHER EXAMPLES

Each of the following non-limiting features in the following examples may stand on its own or may be combined in various permutations or combinations with one or more of the other features in the examples below. In various embodiments, the present disclosure may be implemented as a processor or method.

In some embodiments the present disclosure includes a method, comprising: retrieving, from a database, a training dataset containing a plurality of entries, each entry including a plurality of input variables and a plurality of output variables; determining that there are deterministic relations in the training dataset between the plurality of input variables and the plurality of output variables; in response to determining that there are deterministic relations, training a machine learning model to capture the deterministic relations within the training dataset; determining whether the trained machine learning model has captured all of the deterministic relations within the training dataset; and retraining the trained machine learning model when it is determined that the trained machine learning model has not captured all of the deterministic relations; and returning the trained machine learning model.

In one embodiment, determining whether the trained machine learning model has captured all of the deterministic relations within the training dataset comprises: for each entry in the training dataset: providing the plurality of input variables as input to the trained machine learning model to generate a plurality of predicted outputs, each of the plurality of predicted outputs associated with one of the plurality of output variables from the training dataset; and generating a plurality of residuals, each residual generated by comparing one of the plurality of predicted outputs and its associated output variable; determining whether there is correlation between the plurality of input variables in the training dataset and the plurality of residuals; and determining that the trained machine learning model has not captured all of the deterministic relations when there is correlation between the plurality of input variables in the training dataset and the plurality of residuals.

In one embodiment, deterministic relations remain to be captured for an output variable when the residual associated with the output variable is correlated with at least one of the plurality of input variables.

In one embodiment, generating the plurality of residuals includes calculating the difference between an output variable and the predicted output associated with the output variable when the output variable is ordinal data.

In one embodiment, generating the plurality of residuals includes setting the residual to a value zero when output variable is nominal data and the predicted output associated with the output variable accurately predicts the output variable.

In one embodiment, generating the plurality of residuals includes setting the residual to a value representative of the output variable when the output variable is nominal data and the predicted output associated with the output variable inaccurately predicting the output variable.

In one embodiment, determining that there are deterministic relations in the training dataset includes calculating a Pearson correlation coefficient between the plurality of input variables and the plurality of output variables of the training dataset.

In one embodiment, determining that there are deterministic relations in the training dataset includes calculating a mutual information value between the plurality of input variables and the plurality of output variables in the training dataset.

In one embodiment, determining that there are deterministic relations in the training dataset includes calculating a stochastic independence value between the plurality of input variables and the plurality of output variables in the training dataset.

In one embodiment, retraining the trained machine learning model includes at least one of hyperparameter tuning, modifying the loss function, and modifying the model architecture.

In some embodiments, a system comprises one or more processors; a non-transitory computer-readable medium storing a program executable by the one or more processors, the program comprising sets of instructions for: retrieving, from a database, a training dataset containing a plurality of entries, each entry including a plurality of input variables and a plurality of output variables; determining that there are deterministic relations in the training dataset between the plurality of input variables and the plurality of output variables; in response to determining that there are deterministic relations, training a machine learning model to capture the deterministic relations within the training dataset; determining whether the trained machine learning model has captured all of the deterministic relations within the training dataset; and retraining the trained machine learning model when it is determined that the trained machine learning model has not captured all of the deterministic relations; and returning the trained machine learning model.

In some embodiments, a non-transitory computer-readable medium stores a program executable by one or more processors, the program comprising sets of instructions for retrieving, from a database, a training dataset containing a plurality of entries, each entry including a plurality of input variables and a plurality of output variables; determining that there are deterministic relations in the training dataset between the plurality of input variables and the plurality of output variables; in response to determining that there are deterministic relations, training a machine learning model to capture the deterministic relations within the training dataset; determining whether the trained machine learning model has captured all of the deterministic relations within the training dataset; and retraining the trained machine learning model when it is determined that the trained machine learning model has not captured all of the deterministic relations; and returning the trained machine learning model.

What is claimed is:

1. A method, comprising:
retrieving, from a database, a training dataset containing a plurality of entries, each entry including a plurality of input variables and a plurality of output variables;
determining that there are deterministic relations in the training dataset between the plurality of input variables and the plurality of output variables;
in response to determining that there are deterministic relations, training a machine learning model to capture the deterministic relations within the training dataset;
determining whether the trained machine learning model has captured all of the deterministic relations within the training dataset; and
retraining the trained machine learning model when it is determined that the trained machine learning model has not captured all of the deterministic relations; and
returning the trained machine learning model.

2. The method as in claim 1, wherein determining whether the trained machine learning model has captured all of the deterministic relations within the training dataset comprises:
for each entry in the training dataset:
providing the plurality of input variables as input to the trained machine learning model to generate a plurality of predicted outputs, each of the plurality of predicted outputs associated with one of the plurality of output variables from the training dataset; and
generating a plurality of residuals, each residual generated by comparing one of the plurality of predicted outputs and its associated output variable;
determining whether there is correlation between the plurality of input variables in the training dataset and the plurality of residuals; and
determining that the trained machine learning model has not captured all of the deterministic relations when there is correlation between the plurality of input variables in the training dataset and the plurality of residuals.

3. The method as in claim 2, wherein deterministic relations remain to be captured for an output variable when the residual associated with the output variable is correlated with at least one of the plurality of input variables.

4. The method as in claim 2, wherein generating the plurality of residuals includes calculating the difference between an output variable and the predicted output associated with the output variable when the output variable is ordinal data.

5. The method as in claim 2, wherein generating the plurality of residuals includes setting the residual to a value zero when output variable is nominal data and the predicted output associated with the output variable accurately predicts the output variable.

6. The method as in claim 2, wherein generating the plurality of residuals includes setting the residual to a value representative of the output variable when the output variable is nominal data and the predicted output associated with the output variable inaccurately predicting the output variable.

7. The method as in claim 1, wherein determining that there are deterministic relations in the training dataset includes calculating a Pearson correlation coefficient between the plurality of input variables and the plurality of output variables of the training dataset.

8. The method as in claim 1, wherein determining that there are deterministic relations in the training dataset includes calculating a mutual information value between the plurality of input variables and the plurality of output variables in the training dataset.

9. The method as in claim 1, wherein determining that there are deterministic relations in the training dataset includes calculating a stochastic independence value between the plurality of input variables and the plurality of output variables in the training dataset.

10. The method as in claim 1, wherein retraining the trained machine learning model includes at least one of hyperparameter tuning, modifying the loss function, and modifying the model architecture.

11. A system comprising:
one or more processors;
a non-transitory computer-readable medium storing a program executable by the one or more processors, the program comprising sets of instructions for:
retrieving, from a database, a training dataset containing a plurality of entries, each entry including a plurality of input variables and a plurality of output variables;
determining that there are deterministic relations in the training dataset between the plurality of input variables and the plurality of output variables;
in response to determining that there are deterministic relations, training a machine learning model to capture the deterministic relations within the training dataset;
determining whether the trained machine learning model has captured all of the deterministic relations within the training dataset; and
retraining the trained machine learning model when it is determined that the trained machine learning model has not captured all of the deterministic relations; and
returning the trained machine learning model.

12. The system of claim 11, wherein determining whether the trained machine learning model has captured all of the deterministic relations within the training dataset comprises:
for each entry in the training dataset:
providing the plurality of input variables as input to the trained machine learning model to generate a plurality of predicted outputs, each of the plurality of predicted outputs associated with one of the plurality of output variables from the training dataset; and
generating a plurality of residuals, each residual generated by comparing one of the plurality of predicted outputs and its associated output variable;
determining whether there is correlation between the plurality of input variables in the training dataset and the plurality of residuals; and
determining that the trained machine learning model has not captured all of the deterministic relations when there is correlation between the plurality of input variables in the training dataset and the plurality of residuals.

13. The system of claim 12, wherein deterministic relations remain to be captured for an output variable when the residual associated with the output variable is correlated with at least one of the plurality of input variables.

14. The system of claim 12, wherein generating the plurality of residuals includes calculating the difference between an output variable and the predicted output associated with the output variable when the output variable is ordinal data.

15. The system of claim 12, wherein generating the plurality of residuals includes setting the residual to a value zero when output variable is nominal data and the predicted output associated with the output variable accurately predicts the output variable.

16. The system of claim 12, wherein retraining the trained machine learning model includes at least one of hyperparameter tuning, modifying the loss function, and modifying the model architecture.

17. A non-transitory computer-readable medium storing a program executable by one or more processors, the program comprising sets of instructions for:
retrieving, from a database, a training dataset containing a plurality of entries, each entry including a plurality of input variables and a plurality of output variables;
determining that there are deterministic relations in the training dataset between the plurality of input variables and the plurality of output variables;
in response to determining that there are deterministic relations, training a machine learning model to capture the deterministic relations within the training dataset;
determining whether the trained machine learning model has captured all of the deterministic relations within the training dataset; and
retraining the trained machine learning model when it is determined that the trained machine learning model has not captured all of the deterministic relations; and
returning the trained machine learning model.

18. The non-transitory computer-readable medium of claim 17, wherein determining whether the trained machine learning model has captured all of the deterministic relations within the training dataset comprises:
for each entry in the training dataset:
providing the plurality of input variables as input to the trained machine learning model to generate a plurality of predicted outputs, each of the plurality of predicted outputs associated with one of the plurality of output variables from the training dataset; and
generating a plurality of residuals, each residual generated by comparing one of the plurality of predicted outputs and its associated output variable;
determining whether there is correlation between the plurality of input variables in the training dataset and the plurality of residuals; and
determining that the trained machine learning model has not captured all of the deterministic relations when there is correlation between the plurality of input variables in the training dataset and the plurality of residuals.

19. The non-transitory computer-readable medium of claim 18, wherein deterministic relations remain to be captured for an output variable when the residual associated with the output variable is correlated with at least one of the plurality of input variables.

20. The non-transitory computer-readable medium of claim 18, wherein generating the plurality of residuals includes calculating the difference between an output variable and the predicted output associated with the output variable when the output variable is ordinal data.
